(19) United States
(12) Patent Application Publication
(10) Pub. No.: US 2024/0214828 A1
(43) Pub. Date: Jun. 27, 2024

(54) Auction-Based Resource Allocation in Communication Systems

(71) Applicant: Cable Television Laboratories, Inc., Louisville, CO (US)

(72) Inventors: Lin CHENG, Superior, CO (US); Bernardo HUBERMAN, Palo Alto, CA (US); Lili HERVIEU, Buford, GA (US)

(21) Appl. No.: 18/406,107

(22) Filed: Jan. 6, 2024

Related U.S. Application Data
(63) Continuation-in-part of application No. 18/222,992, filed on Jul. 17, 2023.
Application No. 18/222,992 is a continuation of application No. 17/382,162, filed on Jul. 21, 2021, now Pat. No. 11,706,632.
(63) Continuation-in-part of application No. 17/176,654, filed on Feb. 16, 2021, now Pat. No. 11,888,703.
Application No. 17/176,654 is a continuation of application No. 16/569,021, filed on Sep. 12, 2019, now Pat. No. 10,931,538.
(60) Provisional application No. 63/054,338, filed on Jul. 21, 2020.
(60) Provisional application No. 62/730,966, filed on Sep. 13, 2018.
(60) Provisional application No. 62/856,615, filed on Jun. 3, 2019.
(60) Provisional application No. 63/437,497, filed on Jan. 6, 2023.
(60) Provisional application No. 63/451,032, filed on Mar. 9, 2023.

(51) Int. Cl. H04W 16/14; H04L 41/16; H04W 16/10; H04W 24/02; H04W 28/20; H04W 28/24

(52) U.S. Cl. CPC H04W 16/14; H04L 41/16; H04W 16/10; H04W 24/02; H04W 28/20; H04W 28/24

(57) ABSTRACT

Preference-based downlink resource allocation mechanisms for communication systems, such as low earth orbit satellite communication systems, may be implemented as auctions. Unlike allocation methods that do not take channel diversity into consideration, the disclosed methods improve communication efficiency while reducing uplink overhead compared with methods that feedback complete channel state information (CSI). Moreover, the disclosed methods simplify computational complexity and improve scalability compared with optimal allocation, and enable the derivation of implicit CSI from the submitted requests or bids.

### CROSS-REFERENCE TO RELATED APPLICATIONS

This application is a continuation-in-part of U.S. patent application Ser. No. 18/222,992, filed Jul. 17, 2023, which is a continuation of U.S. application Ser. No. 17/382,162, filed Jul. 21, 2021, now U.S. Pat. No. 11,706,632, which claimed the benefit of and priority to U.S. Provisional Appl. No. 63/054,338, filed Jul. 21, 2020. This application is also a continuation-in-part of U.S. patent application Ser. No. 17/176,654, filed Feb. 16, 2021, which is a continuation of U.S. patent application Ser. No. 16/569,021, filed Sep. 12, 2019, now U.S. Pat. No. 10,931,538, which claimed the benefit of and priority to U.S. Provisional Patent Appl. Nos. 62/730,966, filed Sep. 13, 2018, and 62/856,615, filed Jun. 3, 2019. This application also claims the benefit of and priority to U.S. Provisional Patent Appl. Nos. 63/437,497, filed Jan. 6, 2023, and 63/451,032, filed Mar. 9, 2023. Each of these applications is hereby incorporated by reference in its entirety.

### STATEMENT REGARDING FEDERALLY SPONSORED RESEARCH

None.

### BACKGROUND

In a communication system, multiple users sharing the same downlink channel may observe diverse channel responses. For example, three sets of user equipment (UE) receiving downlink signals from the same base station (BS) observe different signal-to-noise ratios (SNR) or power levels of subchannels (SC) at reception, because of multipaths, frequency selective fading, and interference.

In most traditional communication systems, resources are allocated to UEs in a manner that usually does not fully optimize the spectral efficiency. For example, SCs are allocated to UEs in a frequency division multiplexing (FDM) fashion in the order of UE indices. Such allocation cannot reach the maximal or optimal channel efficiency.

To reach the maximal channel capacity, the BS needs to assign each SC to the absolute strongest UE. However, this is not feasible as one UE may consume all the SCs. In addition, maximal-capacity allocation relies on a full capture of downlink channel responses. Since downlink and uplink channels are usually non-reciprocal for frequency division duplex (FDD) systems, for the BS to have a full capture of the downlink channel responses, the UEs need to feedback complete CSI to the BS. This procedure generates large uplink overhead and reduces the channel efficiency.

An optimal allocation assigns each SC to the comparatively strongest UE with constraints such as demands and fairness. Such allocation can be derived from complicated algorithms. These algorithms sometimes are NP-hard so that even a satisficing solution requires high computational power. In addition, since optimal allocation also relies on complete CSI feedback to the BS, it causes a large uplink overhead.

As low earth orbit (LEO) satellite communication networks begin to pervade people's lives, optimal resource allocation is becoming increasingly important. Although the concept of satellite communication is not new and the cost is still high, developments over the past ten years have made the implementation of LEO satellite networks possible, thanks to a massive reduction in satellite launch costs and new technologies for inter-satellite high bandwidth communications. The satellite Internet is an important component of future 6G communication protocols. In order to provide high-speed and low-latency broadband Internet services, numerous mega constellation plans have been proposed in recent years. The most prominent projects are SpaceX's Starlink, Amazon's Project Kuiper, and the OneWeb constellation, each planning to build networks consisting of hundreds to thousands of LEO satellites. SpaceX plans to build a Starlink constellation composed of about 42000 LEO satellites and to provide communication services with 50-150 Mbps data rate and 20-40 ms delay. Amazon also plans to build the Kuiper constellation, composed of 1980 LEO satellites and to provide communication services with up to 595 Mbps data rate and 32 ms delay. Lastly, China Satellite Network Group, established on Apr. 28, 2021, has integrated domestic mega constellation plans and resources including Hongyun and Hongyan, aimed at building a Chinese version of Starlink.

As LEO satellites run at altitudes around 500-1000 kilometers, the networks improve the achievable latency and bandwidth as compared with traditional GEO satellite networks, making them viable alternatives to land-based and terrestrial networks. In fact, from a quality-of-service perspective, satellite networks might ultimately have the advantage over fiber networks as electromagnetic waves propagate faster in vacuum than in fiber optic cables, while the lack of geographic obstructions allows for more direct communication paths.

The financial feasibility of mega-constellations of LEO satellites relies on reduced launching and manufacturing costs, increasing demand, and improved satellite performance such as digital payloads, steerable multi-beam antennas, advanced modulation and coding schemes, and frequency reuse strategies. An efficient link between satellites and ground stations (GS) with high power efficiency, low overhead, and optimized resource allocation among satellite links, frequency spectrum, and antennae is most important to make LEO satellite coverage cost-effective, considering the nature of LEO satellites and their sensitivity to power consumption and roundtrip delays.

### SUMMARY

The present disclosure generally relates to apparatus, software and methods for preference-based resource allocation for communication systems, such as low earth orbit satellite communication systems. The resources may include, but are not limited to, spectrum, satellite links, or radios. Unlike allocation methods that do not take channel diversity into consideration, the disclosed apparatus, methods and software improve communication efficiency while reducing uplink overhead compared with methods that feedback complete channel state information (CSI). Moreover, the disclosed methods and software simplify computational complexity and improve scalability compared with optimal allocation, and enable the derivation of implicit CSI from submitted requests or bids. In some embodiments, locality-sensitive-hashing (LSH) based prediction performed by a bidding device(s) is/are used for dynamic allocation of resources. The mechanisms disclosed provide a feasible solution for equipment, such as low earth orbit satellites, that are sensitive to power consumption and overheating.

In an aspect, a method for allocating a shared communication resource among a plurality of devices comprises receiving bids from the plurality of devices for the shared communication resource, where the shared communication resource comprises a plurality of resource units that are distributed in space, time, frequency and/or hardware. Each device submits one or more of the bids that combined form one-hundred percent of the device's desired allotment of the shared communication resource and each of the bids specifies a ratio of a percentage of the desired allotment met by a quantity of non-distributed resource units. The method allocates the resource units to the plurality of devices based at least in part on the ratios with highest values, thereby utilizing a small number of the non-distributed resource units to satisfice the devices' desired allotments, and communicates with the plurality of devices according to the allocation.

In an embodiment, each bid comprises a starting resource unit identifier, a total number of non-distributed resource units in the bid, the percentage of the desired allotment met by the bid, and a performance parameter for one of the non-distributed resource units in the bid. For example, the performance parameter may be selected from the group consisting of capacity, signal-to-interference-plus-noise ratio (SINR), modulation error ratio (MER), bit error rate (BER), error vector magnitude (EVM), modulation order and power usage. In an embodiment, the performance parameter is the poorest, the best, the highest, or the lowest performance parameter of any one of the non-distributed resource units in the bid or a median performance parameter of all of the non-distributed resource units in the bid.

In an embodiment, the devices are selected from the group consisting of user equipment, mobile stations, IoT devices, base stations, ground stations and satellites.

In an embodiment, the one or more bids submitted from each device is/are based on device-specific historical data. For example, the device-specific historical data may be selected from the group consisting of channel estimates, complex coefficients, signal-to-noise ratio (SNR), signal-to-interference-plus-noise ratio (SINR), capacity, modulation error ratio (MER), bit error rate (BER), error vector magnitude (EVM), modulation order and received power.

In an embodiment, at least one of the plurality of devices uses a predictive algorithm to identify the resource unit(s) of highest quality. For example, the predictive algorithm performs one or more of locality sensitive hashing (LSH), linear regression, polynomial regression, autoregressive integrated moving averaging (ARIMA), neural networking, recursive neural networking (RNN), Long Short-Term Memory (LSTM), K-nearest neighbor determinations and transformers.

In an embodiment, a method for allocating a shared communication resource among a plurality of devices further comprises identifying ineffective ones of the resource units based on a scarcity of bids for the resource units, and potentially reducing power to the resource unit(s) that is/are ineffective.

In an embodiment, a method for allocating a shared communication resource among a plurality of devices further comprises, after the step of allocating, deducting an amount of budget from each device's account. In an embodiment, a method for allocating a shared communication resource among a plurality of devices further comprises rolling over unused budget to a future auction.

In an embodiment, a method for allocating a shared communication resource among a plurality of devices further comprises periodically repeating the steps of receiving, allocating and communicating, for example, in a series of auctions.

In an embodiment, the shared communication resource is an uplink resource. In an embodiment, the shared communication resource is a downlink resource.

In an embodiment, the shared communication resource is selected from the group consisting of spectrum, an antenna, a transmitter, a radio link, a MIMO beam, a satellite link, a mesh node, a network node, time and space. In an embodiment, the shared communication resource is selected from the group consisting of a set of hardware, which may be co-located (i.e., not spatially distributed) or spatially distributed. For example, a set of hardware may be a set of antennas, a set of transmitters, a set of satellites, a set of base stations, or a set of ground stations. When more than one unit of a hardware set is able to provide the resource to a plurality of devices, each device may bid on which unit of hardware delivers the best quality version of the resource for the best budget to it. In this way, defective or malfunctioning hardware may be identified by a lack of bids.

In an embodiment, none of the devices needs to submit channel state information for the method to satisfice the devices' desired allotments. In an embodiment, none of the devices submit channel state information. In an embodiment, some or all of the devices submit complete or incomplete CSI. In an embodiment, the allocation is not explicitly based on channel state information.

In an aspect, a system for allocating a shared communication resource among a plurality of devices comprises a processor configured to receive bids from the plurality of devices for the shared communication resource, where the shared communication resource comprises a plurality of resource units that are distributed in space, time, frequency and/or hardware. Each device submits one or more of the bids that combined form one-hundred percent of the device's desired allotment of the shared communication resource and each of the bids specifies a ratio of a percentage of the desired allotment met by a quantity of non-distributed resource units. The processor allocates the resource units to the plurality of devices based at least in part on the ratios with highest values, thereby utilizing a small number of the non-distributed resource units to satisfice the devices' desired allotments, and arranges communication with the plurality of devices according to the allocation.

In an embodiment, the processor is further configured to identify ineffective ones of the resource units based on a scarcity of bids for the resource units.

In an embodiment, the processor is further configured to receive bids from the plurality of devices for the shared communication resource, where the shared communication resource comprises a plurality of resource units that are distributed in space, time, frequency and/or hardware. Each device submits one or more of the bids that combined form one-hundred percent of the device's desired allotment of the shared communication resource and each of the bids specifies a ratio of a percentage of the desired allotment met by a quantity of non-distributed resource units. The processor is further configured to allocate the resource units to the plurality of devices based at least in part on the ratios with highest values, thereby utilizing a small number of the non-distributed resource units to satisfice the devices' desired allotments, and communicate with the plurality of devices according to the allocation.

In an embodiment, the plurality of non-transitory instructions is further executable for identifying ineffective ones of the resource units based on a scarcity of bids for the resource units. In an embodiment, the plurality of non-transitory instructions is further executable for reducing power to the resource units that are ineffective.

In an embodiment, the plurality of non-transitory instructions is further executable for deducting an amount of funds or budget from each device's account after the step of allocating.

### BRIEF DESCRIPTION OF THE DRAWINGS

Illustrative embodiments of the present invention are described in detail below with reference to the attached drawings, wherein:

FIG. 1A shows an exemplary timeline of auctions, according to an embodiment;

FIG. 1B shows an exemplary timeline of auctions following LSH training, according to an embodiment;

FIG. 2A is a flowchart illustrating exemplary steps of an auction, according to an embodiment;

FIG. 2B is a flowchart illustrating exemplary steps of an auction including LSD predictions, according to an embodiment;

FIG. 3 is a schematic example illustrating GSs sending bid messages bidding for groups of SCs;

FIG. 4 shows a simulation result of SC allocation at the end of an auction for 16 GSs and 1024 SCs (240-MHz total bandwidth, regional interference at #300-#400 SC, maximum 4 rounds of bidding per auction);

FIG. 5A shows simulation results for average capacity of 16 UEs from 100 allocation trials;

FIG. 5B shows the standard deviation of the data shown in FIG. 5A;

FIG. 6A shows a simulation result for average capacity of 16 GSs from 100 auctions, with comparison with two references;

FIG. 6B shows the standard deviation of data shown in FIG. 6A;

FIG. 7 shows a simulation result for average capacity of 16 GSs versus normalized satellite transmitted downlink power over 100 auctions, with comparison with two references;

FIG. 8 shows a simulation result for uplink overhead from 100 auctions, with an average at 214 bit/auction/GS;

FIG. 9 is a schematic of an SDR experiment setup (512 OFDM SCs, 30-MHZ total bandwidth);

FIG. 10 shows an experimental result for average capacity of 2 receivers versus normalized transmitted downlink power over 100 auctions, with comparison with two references;

FIG. 11 shows a simulation result for average deal price of 1024 SCs revealing the frequency of interference; and

FIG. 12 shows an experimental result for average capacity of 2 receivers versus transmitted downlink power, with comparison with two references (40-MHz total bandwidth, 600 OFDM subcarriers as SCs, 50-kHz subcarrier spacing, 2.44-GHz central frequency, d=20, k=50, max # of bids=4, rollover).

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

As used herein, the term “bid” refers to a request for the right to utilize a portion of a communication resource in exchange for a quantity of a budget. Competing bids may be compared to each other (e.g., in an auction) at least partially based on the amount of budget offered for the portion of the communication resource requested. For example, the budget may be a numerical value, a ranking series, a monetary fund, or any other quantifiable unit used by all bidders.

As used herein, a “desired allotment” of a communication resource is the amount of communication resource a device bids on to satisfy its needs for a time period covered by an auction. It should be understood that a desired allotment may be for less of the communication resource than the device is entitled to use (authorized allotment), e.g., based on a service level agreement. This may occur, for example, when utilization of the device is low. In some embodiments, received bids may be checked to ensure that desired allotments do not exceed the amount of communication resource the device is entitled to use (i.e., the authorized allotment).

As used herein, the term “distributed” refers to the relationship of elements forming a set where the elements are spread across a range of values. For example, a set of elements may be distributed in time (e.g., time slots), space (e.g., antennas that are not co-located), frequency (e.g., subchannels) and/or hardware (e.g., antennas that are co-located). A “block” of distributed elements is a contiguous subset of the elements in the set (i.e., a group of two or more neighboring elements in the set).

As used herein, the term “fragmentary” refers to elements or blocks of a distributed set that are disconnected or spaced apart from one another by at least one intervening element or block of the set.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third component).

As used herein, “channel state information” (CSI) refers to the known channel properties of a communication link. The CSI describes how a signal propagates from the transmitter to the receiver and represents the combined effect of, for example, scattering, fading, and power decay with distance.

As used herein, the term “satisfice” refers to an allocation of resource units that may or may not be the best possible allocation, but which does not violate the terms of a service level agreement (SLA), a quality of experience (QoE) metric, or another quality of service (QOS) metric.

As used herein, the term “network” refers generally to any type of telecommunications or data network including, without limitation, hybrid fiber coaxial (HFC) networks, satellite networks, telco networks, and data networks (including MANs, WANS, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, LTE/LTE-A, WAP, SIP, UDP, FTP, RTP/RTCP, H.323, etc.).

As used herein, the term “channel” or “communication channel” refers to a physical transmission medium, such as a wire or optical cable, or a designated non-tangible broadcast medium, such as a wavelength used to convey an information signal from a sender(s) to a receiver(s). A channel has a certain capacity for transmitting information, often measured by its bandwidth in Hz or its data rate in bits per second.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Disclosed herein are system, methods and software for allocating a shared communication resource among a plurality of devices. The systems, methods and software assume that devices on the same network have access to and share the same resources. Examples of systems and methods implemented in UE-BS and GS-satellite configurations are described herein. However, those of skill in the art will understand that other bidding device-provider device pairings are possible. Such pairings include but are not limited to Optical Network Terminal (ONT)-Optical Line Terminal (OLT), Cable Modem (CM)-Cable Modem Termination System (CMTS), and Mobile Station-Access Point (AP). Further, the pairings may be wired and/or wireless. In addition, the systems and methods disclosed herein are illustrated in a one-to-many configuration, where one transmitter provides a resource to many receivers. It should be understood that the systems and methods disclosed herein may also be implemented in many-to-many configurations. For example, where many resource users send bids for a shared communication resource to an auctioneer, e.g., a processor acting as an intermediary, that matches each of the bids to one of many devices capable of providing the shared communication resource.

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

The embodiments herein may be implemented in a variety of ways as a matter of design choice. In this regard, the invention can take the form of an entirely hardware embodiment, an entirely software embodiment or an embodiment containing both hardware and software elements. In an embodiment, the invention is implemented in software, which includes but is not limited to firmware, resident software, microcode, etc. Furthermore, the invention can take the form of a computer program product accessible from the computer readable medium providing program code for use by or in connection with a computer or any instruction execution system. For the purposes of this description, the computer readable medium can be any apparatus that can tangibly store the program for use by or in connection with the instruction execution system, apparatus, or device, including the computer system.

The systems, software and methods disclosed herein are further illustrated by the following Examples. These Examples are for illustrative purposes only and are not intended to limit the invention.

### Example 1: Preference-Based Downlink Resource Allocation in Communication Systems

In order to explain one method of using preferences to determine downlink resource allocations, we will use the allocation of frequency SCs in this example.

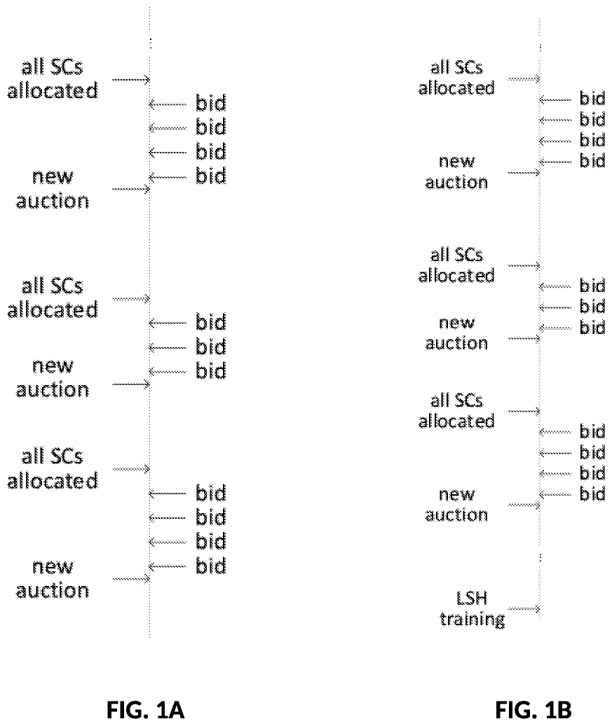

Each allocation process consists of multiple rounds of request submissions at the end of which the allocation of SCs is determined. The allocations occur periodically over time and their period length is determined by the nature of channel fading and overhead requirement. For example, fast fading channels require short allocation periods; low overhead requires long allocation periods. As shown in FIG. 1A, a new allocation/auction starts at the beginning of each period.

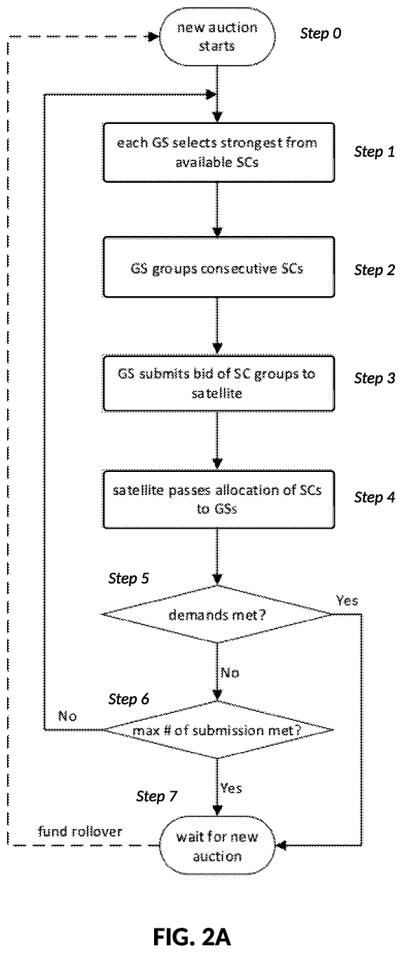

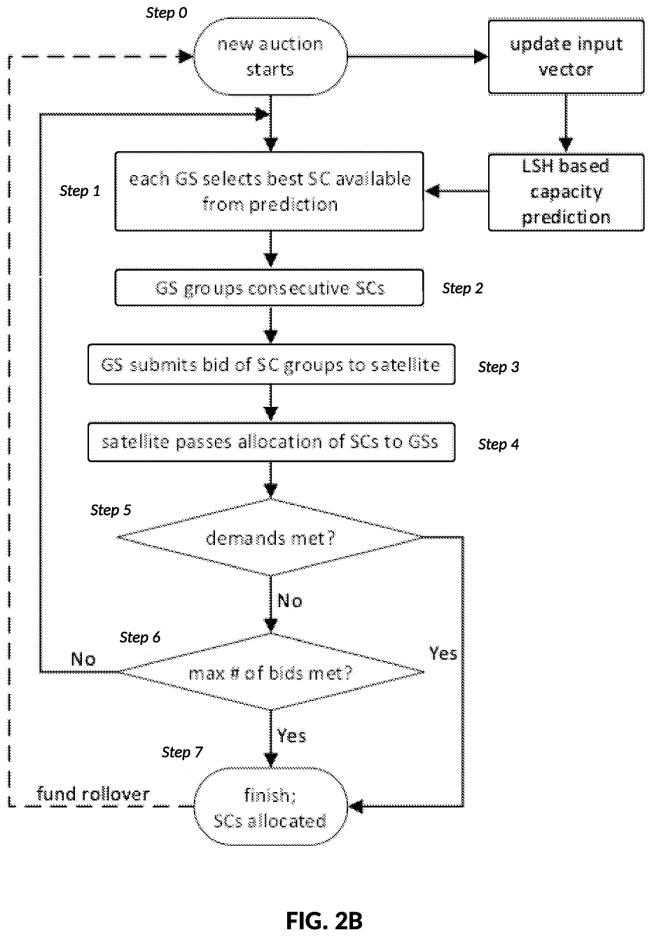

The algorithm is illustrated in FIG. 2A. Assume there are NUEs sharing S downlink SCs.

Step 0: At the start of an allocation/auction, new spectral budget is added to each UE's record. These records are kept at the BS or inside a server that the BS can access. These records may or may not be accessible to the UEs. The amounts of the budgets are determined by other criteria such as demands, priorities, service levels, etc. The status of all the SCs are reset to “available” at this step. The UEs also have channel estimates (complex coefficients, SNR, or received power) available for the SCs.

Step 1: Each UE estimates the capacity of each SC based on its channel estimates. The capacity of unavailable SCs is set to zero. Each UE sorts the SCs in the order of the capacities. The SCs are denoted as c₁, c₂, . . . c_{S} before sorting. After sorting, the SCs are indexed as c_{n,i}_{₁}, c_{n,i}_{₂}, . . . c_{n,i}_{_{S}} at UE n, 1≤n≤N. SC c_{n,i}_{₁} has the highest capacity of all SCs at UE n. UE n selects S′ₙ SCs that have the highest capacity. These S′ₙ SCs are the SCs to request for the current round of submissions. The number of SCs S′ₙ is determined by the capacity distribution of SCs. An example of how S′ₙ is determined is

$${S}_{n}^{′} = {arg max}_{j} ( {\sum }_{q = 1}^{j} {C}_{n , {i}_{q}} - \frac{j {\sum }_{q = 2}^{S} {C}_{n , {i}_{q}}}{S - 1} + \frac{{\sum }_{q = 1}^{S} {C}_{n , {i}_{q}} {\_SC}_{n , {i}_{1}}}{S - 1} )$$

where C_{n,i}_{_{q}} is the capacity of SC C_{n,i}_{_{q}}, 1≤q≤S, at UE n. Determining S′ₙ in such a way can avoid requesting unavailable SCs. It also allows UEs with strong fading to automatically put higher preference on good SCs while UEs with flatter channel automatically back up during the first rounds of submission—both spectral efficiency and fairness play a role in the allocation. S′ₙ is also bound by parameters such as demands, fairness, etc.

Step 2: Thanks to the nature of fading and interference, the selected SCs by each UE in Step 1 are mostly fragmentary, i.e. selected SCs can be divided into a small number of groups and each group of SCs has continuous indices. Assume UE n has Gₙ groups of selected subcarriers, G_{n,1}, G_{n,2}, . . . G_{n,c}_{ₙ}. The UE assigns preferences to these groups. An example of preference assignment is as follows. Each UE n first assigns a ratio

$${b}_{n , g} = {\sum }_{i ∈ {G}_{n , g}} {C}_{n , i} / {\sum }_{i ∈ {U}_{g} {G}_{n , g}} {C}_{n , i}$$

to each group G_{n,g}. UE n sends this ratio, b_{n,g}, to the BS. The BS counts the preference of each of the SCs in G_{n,g} from UE n. The preference value is expressed as

$$\frac{{b}_{n , g}}{\vert {G}_{n , g} \vert} {M}_{n}$$

where Mₙ is the current total amount of available budget in UE n's record, |⋅| denotes the total SC number in a group.

Step 3: The UEs send their request to the BS through the control channel in uplink. Each group of SCs to request contains four mandatory fields: index of starting SC, total SC number in the group |G_{n,g}|, ratio b_{n,g}, and the lowest SNR (or capacity, or spectral efficiency, or power) of the SCs in the group.

Step 4: The BS or the server allocates each SC that receives at least one request submission to the UE that has the highest preference value. The allocation should also meet other constraints such as maximal number of SCs per UE allowed, airtime fairness, etc. The BS or the server also updates that UE's record by deducting a certain amount from the record. An example of how much is deducted from the record is the preference value,

$$i . e . \frac{{b}_{n , g}}{\vert {G}_{n , g} \vert} {M}_{n} .$$

Another example is the second highest preference value, if the second highest preference value exists. The BS then sends the allocation (and optionally the account balance) information of successfully assigned SCs to UEs through the control channel in downlink. UEs set the status of all the assigned SCs to “unavailable”.

Step 5: Each UE decides whether its capacity demand is met.

Step 6: Each system decides if the total number of rounds of request submissions has exceeded a certain number.

Step 7: The system continues or carries out data transmission using the final SC allocation for downlink. UEs' records may or may not reset to zero (i.e. rollover or not).

### Simulation

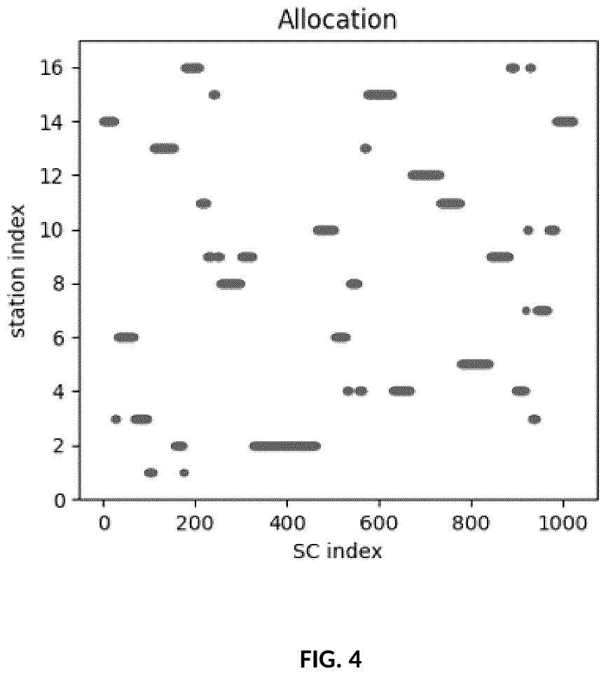

A Python simulation of the method was carried out. 16 UEs and 1024 SCs were included in the simulation. An example of how SCs are allocated at the end of an allocation, i.e. Step 7, is shown in FIG. 4. Downlink transmission experiences frequency selective fading caused by multipath and interference.

### Efficiency Improvement

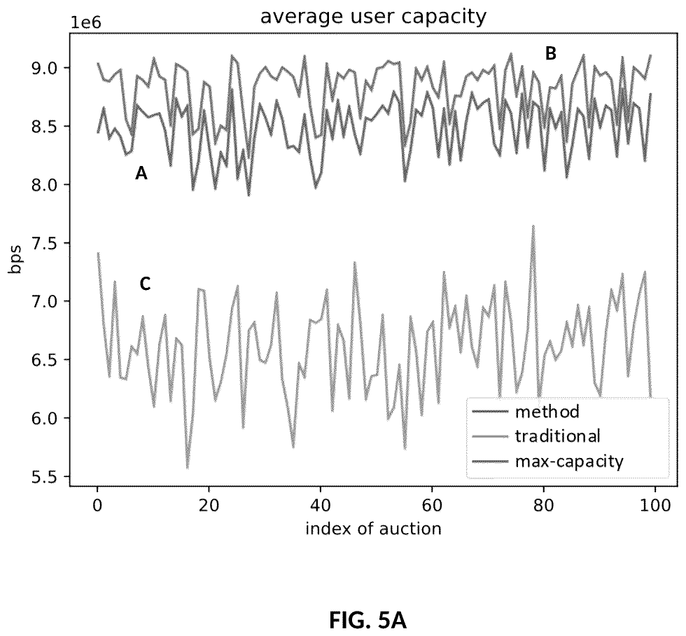

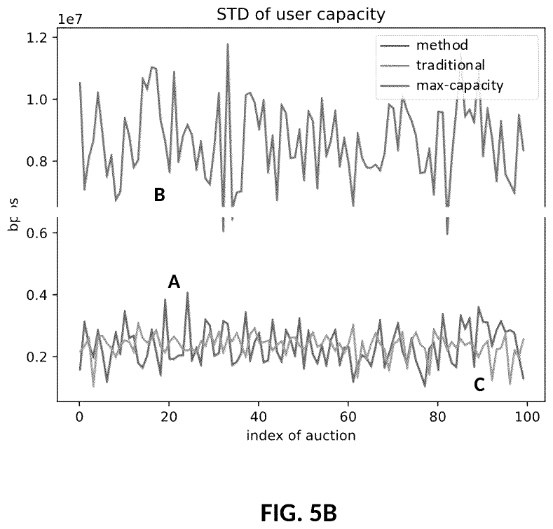

The method improves communication efficiency compared with traditional allocation methods that do not take channel diversity into consideration. Curve A in FIG. 5 shows an example of the average capacity of the 16 UEs provided by 100 allocation trials (i.e. run Steps of Allocation 100 times for 100 instances of channel models) from the simulation. Curve C shows the corresponding result of a traditional allocation method where SCs are allocated to UEs in an FDM fashion in the order of UE indices. On average the present method has 30% improvement in this case, subject to other parameters such as channel fading, interference strength, UE diversity, etc. In addition, curve B shows the corresponding result of a maximal-capacity allocation method where the BS assigns each SC to the absolute strongest UE without any fairness. The proposed method has a small decrease relatively, while it guarantees much better fairness, which can be examined by measuring the standard deviation of the capacity as shown in FIG. 5B.

### Overhead Reduction

The method reduces uplink overhead compared with systems that feedback complete CSI. To feedback complete CSI, each UE needs to send the complex coefficients, SNR, or received power of each SC to the BS. For 1024 subcarriers, as an example (same as used in the simulation), assuming the CSI for each SC takes 10 bits, the total uplink traffic is 10,240 bits per user every time the SC allocation updates.

Assuming each submitted request message takes 40 bits (10 bits each field) in Step 3, the uplink traffic for the present method is 100-700 bit/UE/allocation. Compared with 10,240 bit/user per update, the method provides significant overhead reduction in uplink.

The method has downlink overhead similar to other methods and is already minimal.

### Low Computational Complexity

The method simplifies computation complexity compared with optimal allocation. Optimal allocation, as aforementioned, is NP-hard while the computational complexity of this method is O(S log² n) at the BS and O(log² S) at each UE. This also makes the method scale more feasibly when the number of UEs and/or the number of SCs increase.

### Channel Status Implication

The method enables the derivation of implicit channel information from the allocation process. There are multiple scenarios and applications of this feature of the method. Two examples are as follows.

### Allocation of Unassigned SCs

Depending on the setup of the implemented method, there may be a small number of unassigned SCs at the end of an allocation. Instead of leaving these SCs idle, the BS or the server can allocate these SCs to UEs without deducting budget from UEs' records. The question is which UE to allocate to so that the SCs can have their best utility in terms of spectral efficiency. To answer this question, we consider an example where the first and last SCs are unassigned. The BS or the server checks the history of the UEs' submitted requests and finds that one of the UEs requested the last SC. Considering the nature of channel fading, the capacity of the first SC at the UE should be similar to that of the last SC which the UE requested as one of its strongest SCs. Therefore, it makes sense to allocate the first SC to the UE.

Where one or more UEs have records of requesting a SC neighboring an unassigned SC (e.g. second to last SC), and considering the nature of channel fading, the last SC should be relatively strong compared with other unwanted SCs for UEs that have requested neighboring SCs. After further comparing the SNR field of the request messages from these UEs, the BS or the server decides to allocate this SC to the UE that has a SC with a strong SNR next to the unsold SC.

### Interference Detection

If a SC is left unassigned repeatedly over many allocations, it is a sign that there may exist regional interference over the SC. In this case, the BS may decide to keep the SC or SCs idle and adjust its power loading, i.e. power is unloaded from these interfered SCs to other useful SCs.

Other than monitoring the request history, a better way to detect regional interference is to monitor the winner preference values over allocations. To show how this works, we added interference by decreasing the SNR of SC #301-#400 among the 1024 SCs in the simulation. After 100 allocation trials (i.e. run Steps of Allocation 100 times for 100 instances of channel models), the winner preference values averaged over the 100 allocations clearly showed which SCs are interfered with and also the accurate location of the interference.

Monitoring interference using winner preference values provides higher accuracy than monitoring using submitted request messages. This is because it is very likely that an interfered SC is still requested and assigned as an “undesired” SC at the end of an allocation after no UEs request it for the first several rounds of request submissions.

The method disclosed herein is described as using point-to-mulitpoint communication as an example, but the method also applies in multipoint-to-multipoint communication. The description also uses SCs in the frequency domain as the example of resources to be allocated, but the method also applies in the allocation of other types of resources, e.g. OFDM subcarrier, time slots, spatial streams, etc. The description also uses terminology such as BS and UE whereas the method is not limited to cellular mobile communication.

### Example 2: Auction-Based Operation in LEO Satellite Systems for High-Efficiency Communications

An optimal- or maximal-capacity communication link between satellites and ground stations assigns each resource unit to the comparatively strongest GS with constraints such as demands and fairness. Such allocations are usually derived from complicated algorithms. However, these algorithms are sometimes NP-hard, so that even a satisficing solution requires high computational power and overhead. In addition, the optimization of downlink allocations highly relies on satellites' knowledge of GSs' receiving status. Optimal allocation needs complete channel status fed back to satellites, causing a large uplink overhead.

Here, we disclose an auction-based mechanism for LEO satellite systems. Different from other analytical and optimization approaches, the auction-based mechanism:
improves total channel capacity by dynamically leveraging the diversity among satellite-station links;
reduces uplink overhead by providing lightweight and effective channel status feedback;
simplifies computational complexity and improves scalability; and
enables the derivation of implicit resource information from auctions.

The method is an enabling strategy for efficient communications between satellites and GSs with high power efficiency, low overhead, and optimized resource allocation among satellite links, frequency spectrum, and antennae.

### Auction-Based Operation

In order to explain this method, the allocation of frequency sub-channels (SC) or subcarriers is used as an example. However, the method may also apply in the management of other components such as radio links, MIMO beams, transmitters and their antennae, or even satellites.

SCs experience multipath induced frequency-selective fading and frequency-selective interference, leading to different capacities on different SC resources.

Each auction includes multiple rounds of bidding at the end of which the allocation of SCs is determined. The auctions occur periodically over time and their period length is determined by the nature of channel fading and overhead requirement. For example, fast fading channels require short auction periods; low overhead requires long auction periods. As shown in FIG. 1A, a new auction starts at the beginning of each period.

The method is illustrated in FIG. 2A. Assume there are N GSs sharing S downlink SCs.

Step 0: At the beginning of an auction, new funds are added to GSs' accounts that are kept at the satellite. These accounts may or may not be accessible to the GSs. The amounts of the funds are determined by other criteria such as demands, priorities, service levels, etc. Note, however, that fund exchange does not necessarily involve monetary behavior from the GSs or users. In other words, the fund assigned to a GS is solely a variable for the sake of the auction mechanism. The status of all the S SCs is reset to “available” at this step. The GSs also have channel estimates (complex coefficients, SNR, or received power) available for the SCs.

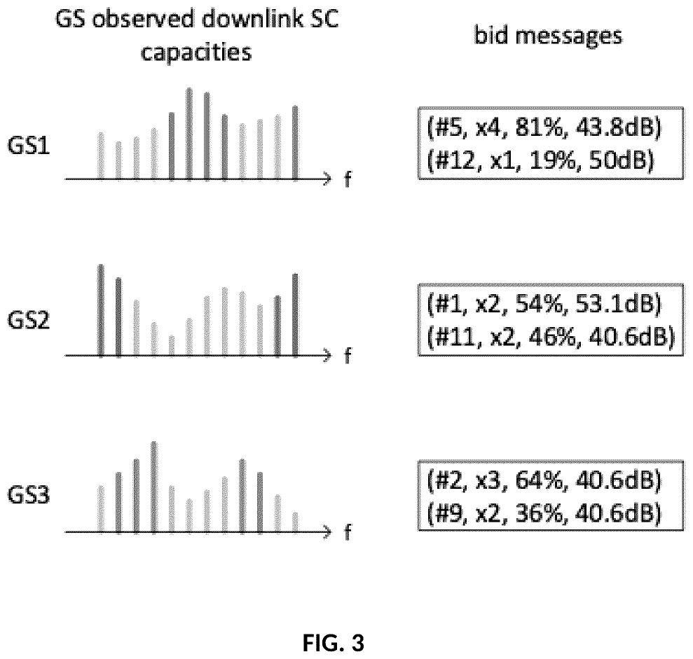

Step 1: Each GS estimates the capacity of each SC based on its channel estimates. The capacity of unavailable SCs is set to zero. Each GS sorts the SCs in the order of the capacities. The SCs are denoted as c₁, c₂, . . . c_{S} before sorting. After sorting, the SCs are indexed as c_{n,i}_{₁}, c_{n,i}_{₂}, . . . , c_{n,i}_{_{S}} at GS-n, 1≤n≤N. Sc c_{n,i}_{₁} has the highest capacity of all SCs at GS-n. GS-n selects S′ₙ SCs that have the highest capacity. These S′ₙ SCs are the SCs to bid for the current round of bidding. The number of SCs S′ₙ is determined by the capacity distribution of SCs. An example of how S′ₙ is determined is

$${S}_{n}^{′} = {arg max}_{j} ( {\sum }_{q = 1}^{j} {C}_{n , {i}_{q}} - \frac{j {\sum }_{q = 2}^{S} {C}_{n , {i}_{q}}}{S - 1} + \frac{{\sum }_{q = 1}^{S} {C}_{n , {i}_{q}} {\_SC}_{n , {i}_{1}}}{S - 1} )$$

where C_{n,i}_{_{q}} is the capacity of SC c_{n,i}_{_{q}}, 1≤q≤S, at GS-n. Determining S′ₙ in such a way can avoid bidding on unavailable SCs. It also allows GSs with strong fading to automatically put higher bids on good SCs while GSs with flatter channels automatically back up during the first rounds of bidding—both spectral efficiency and fairness play a role in the auction. S′ₙ is also bound by parameters such as demands, fairness, etc.
Step 2: Thanks to the nature of fading and interference, the selected SCs by each GS in Step 1 are mostly fragmentary, i.e., selected SCs can be divided into a small number of groups and in each group SCs have continuous indices, as shown in FIG. 3. Assume GS-n has Gₙ groups of selected subcarriers, G_{n,1}, G_{n,2}, . . . G_{n,G}_{ₙ}. In the example in FIG. 3, G=2 for all three GSs, i.e., every GS bids for two groups of SCs. The GS assigns bid prices to these groups. An example of bid price assignment is as follows. Each GS-n first assigns a ratio

$${b}_{n , g} = {\sum }_{i ∈ {G}_{n , g}} {C}_{n , i} / {\sum }_{i ∈ {⋃}_{g} {G}_{n , g}} {C}_{n , i}$$

to each group G_{n,g}. GS-n sends this ratio, b_{n,g}, to the satellite. The satellite counts the bid price of each of the SCs in G_{n,g} from GS-n as

$$\frac{{b}_{n , g}}{\vert {G}_{n , g} \vert} {M}_{n}$$

where Mₙ is the current total amount of funds in GS-n's account, |⋅| denotes the total SC number in a group.
Step 3: The GSs send their bids to the satellite through the control channel in uplink. An example of the bid messages is shown in FIG. 3. Each group of SCs to bid contains four mandatory fields: index of starting SC, total SC number in the group |G_{n,g}|, ratio b_{n,g}, and the lowest capacity (or SNR, or spectral efficiency, or power) of the SCs in the group.

Step 4: The satellite allocates each SC that receives at least one bid to the GS that offers the highest bid. The allocation should meet other constraints such as maximal number of SCs per GS allowed, airtime fairness, etc. The satellite also updates that GS's account by deducting a certain amount from the account. An example of how much is charged to the account is the bid price, i.e.,

$$\frac{{b}_{n , g}}{\vert {G}_{n , g} \vert} {M}_{n} .$$

Another example is the second highest bid price, if the second highest bid price exists. The satellite then sends the allocation (and optionally the account balance) information of successfully sold SCs to GSs through the control channel in downlink. GSs set the status of all the sold SCs to “unavailable”.

Step 5: The satellite decides on whether each GS's capacity demand is met based on the downlink traffic that has been or is to be sent.

Step 6: Each system decides if the total number of rounds of bidding has exceeded a certain number.

Step 7: The system continues or carries out data transmission using the final SC allocation for downlink. GSs' accounts may or may not reset to zero, i.e., rollover or not.

It is worth noting that downlink payload data transmission does not have to wait until the end of the auction process to start. The downlink transmission proceeds with the allocation from the previous auction result and then updates its allocation once the ongoing auction finishes. In other words, auctions proceed and update the allocation with the control channel and data channel going on concurrently.

### Simulation and Experiment

A Python simulation of the method is demonstrated in this section. FIG. 4 shows an example of how SCs are allocated at the end of an auction, i.e., Step 7, from the simulation. 16 GSs and 1024 SCs were included. Downlink transmission experiences frequency selective fading caused by multipath and interference.

### Efficiency Improvement

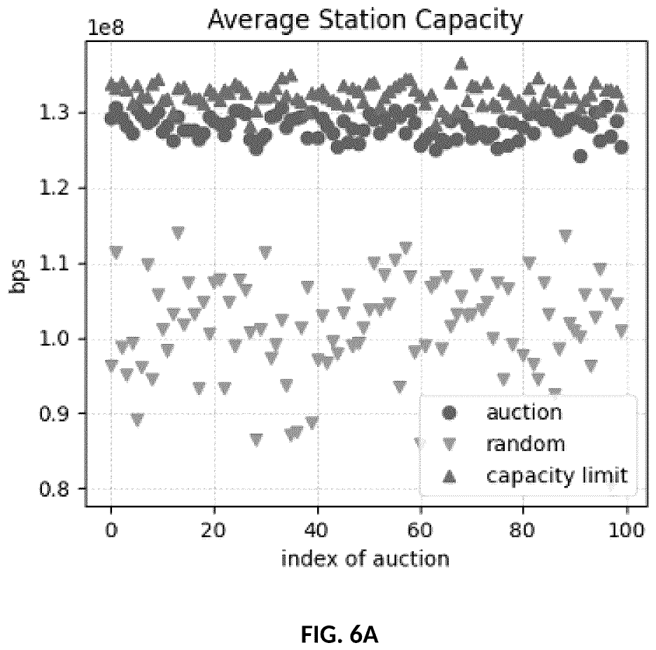

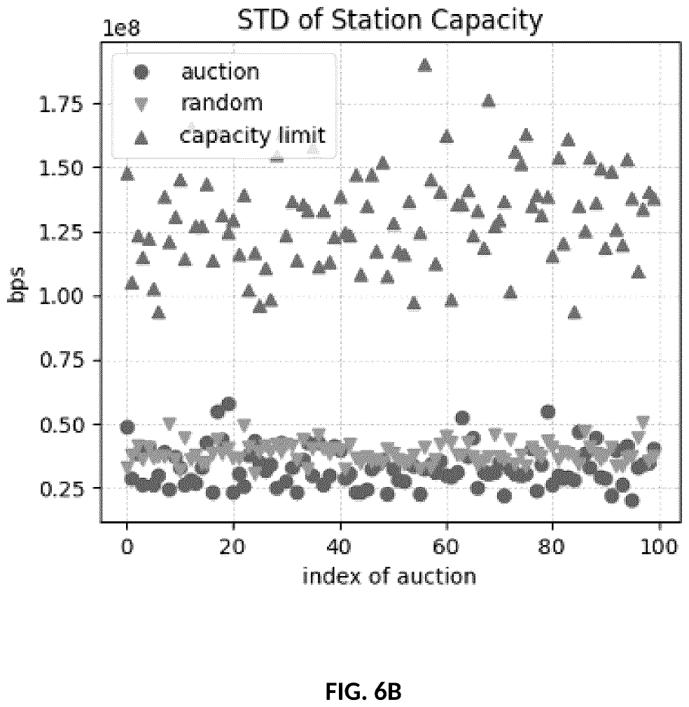

The method improves communication efficiency compared with random allocations, which do not take resource diversity into consideration. The circles in FIG. 6A show an example of the average capacity of the 16 GSs provided by 100 auction trials, i.e., run Steps of Auction 100 times for 100 instances of channel models, from the simulation. The inverted triangles show the corresponding result of allocation where SCs are allocated to GSs randomly. On average the method shows a 29% improvement in this case, subject to other parameters such as channel fading, interference strength, GS diversity, etc. In addition, the triangles show the capacity limit of the system, i.e., a satellite assigns each SC to the absolute strongest GS without any fairness. The auction-based method has a small decrease relatively, while it guarantees much better fairness which can be examined by measuring the standard deviation of the capacity among the 16 GSs, as shown in FIG. 6B.

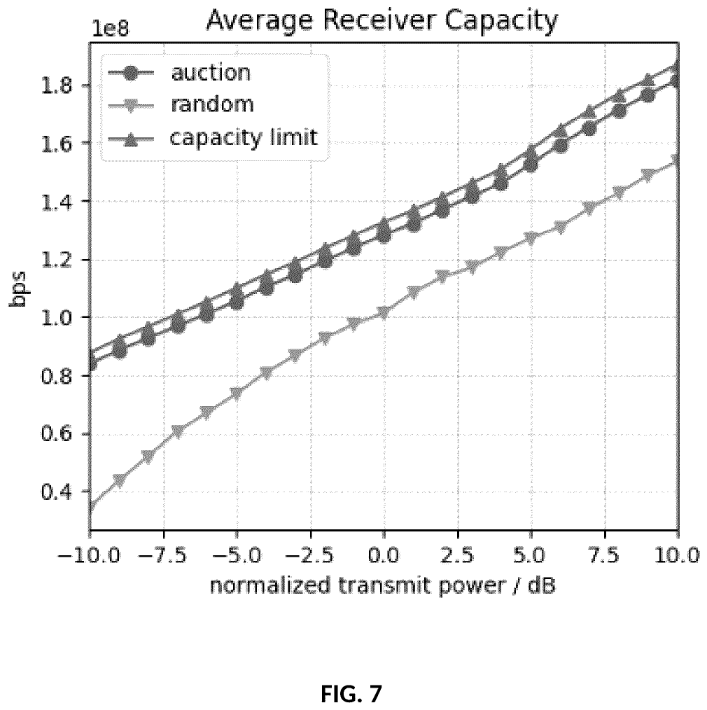

The method's performance on average capacity versus normalized transmitted downlink power was also tested, as shown in FIG. 7, in order to examine the fidelity of the method under different SNR conditions. Consistent with FIG. 6A, the method showed obvious improvement compared with randomly allocating SCs to GSs while having a small gap from capacity limit. On average, there is a 5-dB difference between the disclosed method and randomly assigning SCs, which is power saving for LEO satellites.

### Overhead Reduction

Theoretically, this methodology has a downlink overhead similar to other methods. On the other hand, the disclosed mechanism reduces uplink overhead compared with systems that feedback complete channel status. To feedback complete channel status, each GS needs to pass a large amount of information containing complex coefficients, SNR, or received power of each SC to the satellite. For 1024 subcarriers as an example, the same as what we used in the simulation, assuming the channel status for each SC takes 10 information bits to describe the channel characteristic, the total uplink traffic is ˜10K information bits per user every time the SC allocation updates.

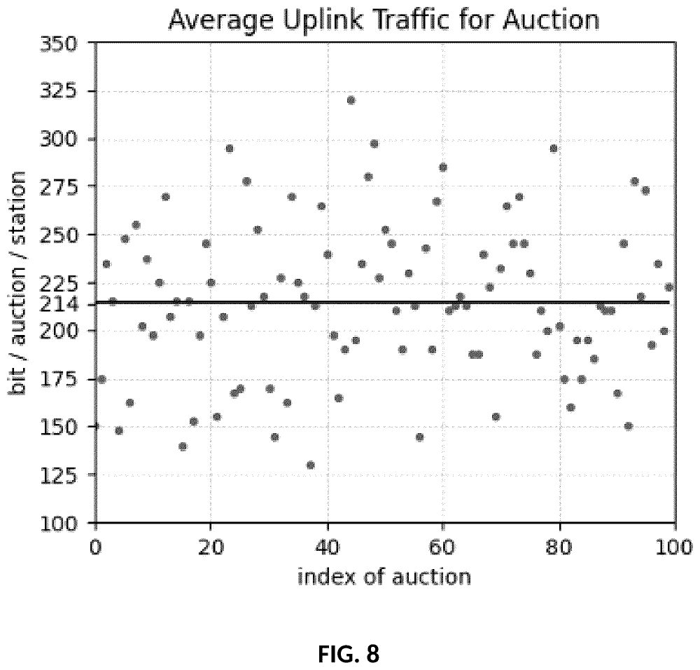

In the disclosed method, assuming each bid message takes 40 bits (10 bits each field) in Step 3, FIG. 8 shows the uplink traffic in bit/auction/GS to show the overhead occupancy of the uplink control channel provided by 100 auction trials from the simulation. The average overhead for each GS every update is 214 bits. Compared with ˜10 Kbit per GS per update, the present method provides significant overhead reduction in uplink while performing similarly to a complete-information channel status feedback.

### Low Computational Complexity

The disclosed method simplifies computation complexity compared with optimal allocation. Optimal allocation, as aforementioned, is NP-hard while the computational complexity of the present method is O(S log² N) at the satellite and O(log² S) at each GS. This also makes the method scale more feasibly when the number of GSs and/or the number of SCs increases.

### Experiment Setup

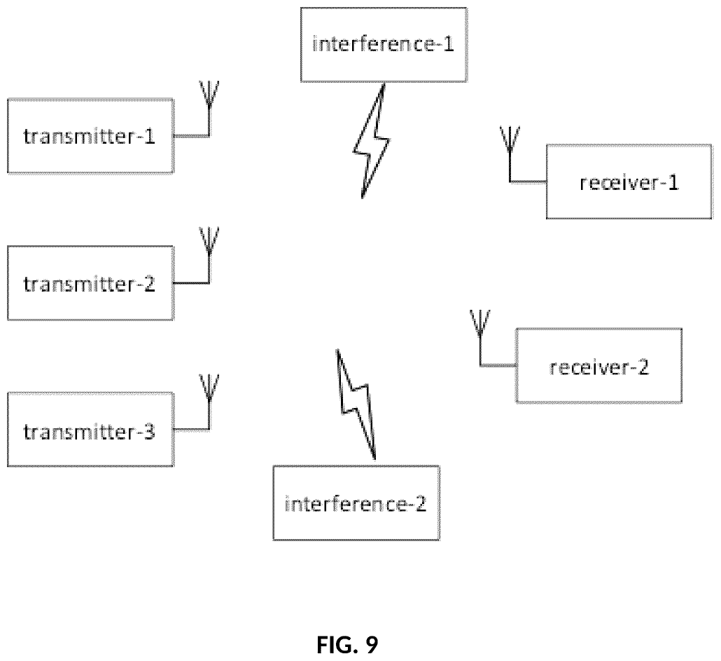

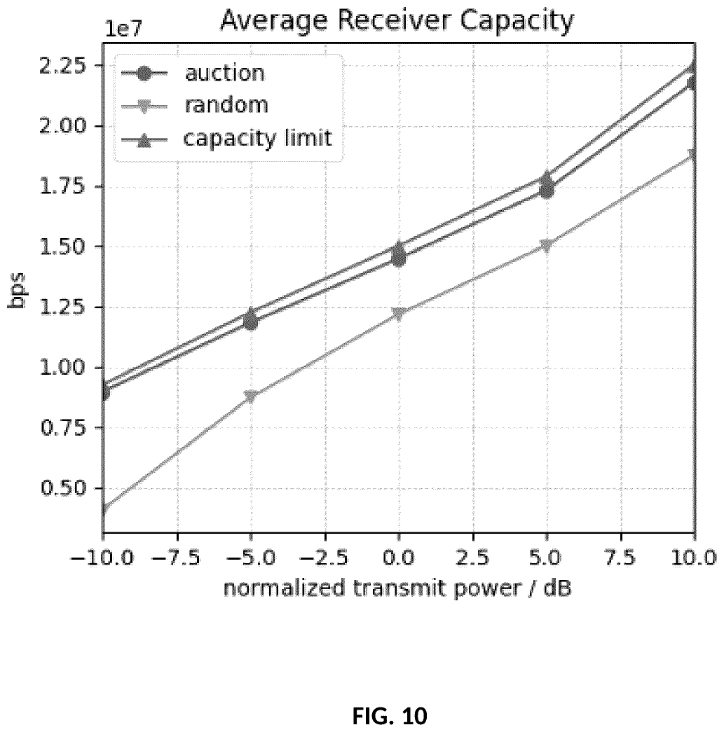

A software-defined radio (SDR) setup with three transmitters (behaving as satellite transmitters) and two receivers (behaving as two GSs) was built, as shown in FIG. 9. The setup also included two interference sources that provided higher diversity. The transmitters and receivers ran the auction mechanism in GNU Radio. We tested its performance on average capacity versus normalized transmitted downlink power over 100 auctions. As shown in FIG. 10, the method showed obvious improvement compared with randomly allocating SCs to receivers while having a small gap from capacity limit. This experimental result is consistent with the simulation result in FIG. 7. A 4.7-dB power saving is observed on average. Although it is a promising saving, it is lower than the 5-dB saving in the simulation result, especially at a high-power region due to the lower number of receivers in the experiment setup.

### Channel Status Implication

The disclosed method enables the derivation of implicit channel information from the auctions. There are multiple scenarios and applications of this feature of the method. Two examples are as follows.

### Unsold SCs

Depending on the setup of the implemented method, there may be a small number of unsold SCs at the end of an auction. Instead of leaving these SCs idle, the satellite can allocate these SCs to GSs for free. The question is which GS to allocate to so that the SCs can have their best utility in terms of spectral efficiency. To answer this question, we consider the example in FIG. 3 where we assume the first and last SCs are unsold. The satellite checks the record of the GSs' bid messages and finds that GS-2 bid for the second SC. Considering the nature of channel fading, the capacity of the first SC at GS-2 should be similar to that of the second SC which GS-2 bid as one of its strongest SCs. Therefore, it makes sense to allocate the first SC to GS-2. Both GS-2 and GS-1 have records of bidding for the second to last SC. Again, considering the nature of channel fading, the last SC should be relatively strong compared with other unwanted SCs for these two GSs. After further comparing the SNR field of the bid messages from these two GSs, the satellite decides to allocate this SC to GS-1 as it has a 50-dB SC group next to the unsold SC.

### Interference Detection

If a SC is left unsold repeatedly over many auctions, it is a sign that there may exist regional interference over the SC. In this case, the satellite may decide to keep the SC idle and adjust its power loading, i.e., power is unloaded from the interfered SC to other useful SCs.

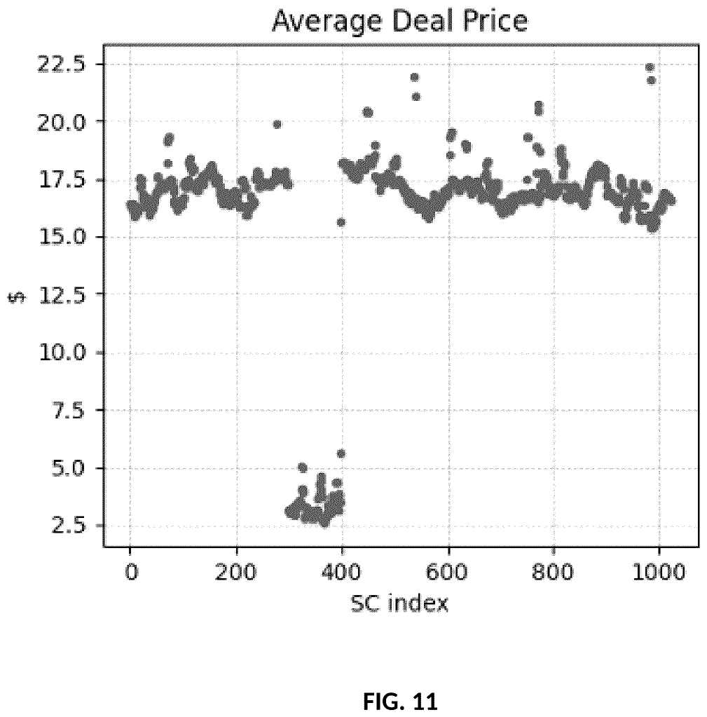

Other than monitoring the sale record, a better way to detect regional interference is to monitor the transaction price over auctions. To show how this works, we added interference by decreasing the SNR of SC #300-#400 among the 1024 SCs for all the 16 GSs in the simulation. After 100 auction trials, FIG. 11 shows the transacted prices averaged over the 100 auctions. These prices clearly imply which SCs are interfered with. Further power loading can be implemented based on this implication to improve power efficiency.

We point out that monitoring interference using deal price provides higher accuracy than monitoring using bid messages. This is because it is very likely that an interfered SC is still bid for and sold as “cheap merchandise” at the end of an auction after no GSs bid for it for the first several rounds of bidding. As shown, for example, in FIG. 4, the interfered SC #301-#400 are successfully sold to GS-2, 8, and 9 although at much lower prices.

### Discussion

This example uses point-to-multipoint communication, but the method also applies in multipoint-to-multipoint communication. In fact, in the experiment aforementioned, we applied the method in a multipoint-to-multipoint setup. We have used the allocation of SCs as the example whereas the disclosed operation mechanism also applies in the management of spatial streams, radios, antennae, satellites, etc.

### Conclusion

An auction-based mechanism is disclosed to improve the efficiency of low earth orbit satellite communication systems. The auction process allows the ground stations to bid for downlink resources such as spectrum, satellite links, or radios, without the need of sending redundant channel status back to satellites and thus saves roundtrip overhead. Simulations and experimental results demonstrate that the mechanism improves total channel capacity by dynamically leveraging the diversity among satellite-station links; reduces uplink overhead by providing lightweight and effective channel status feedback; simplifies computational complexity and improves scalability; and also enables the derivation of implicit resource information from auctions. This operation mechanism provides a feasible solution for low earth orbit satellites that are sensitive to power consumption and overheads.

### Example 3: Satellite Resource Allocation Via Dynamic Auctions and LSH-Based Predictions

This example uses the allocation mechanism of Example 2 along with a fast-acting prediction on the quality of resources at each GS. An LSH-based prediction inspired by a model built for a biological neural system has been built and implemented, which does not require an excessive amount of floating-point operations. Instead, the disclosed method runs with mainly binary data operations and fast hash maps, such that it provides the system with low-algorithmic complexity.

The method is illustrated in FIG. 2B. Assume there are N GSs sharing S downlink SCs.

Step 0: At the beginning of an auction at time t, new funds are added on top of any leftover from previous auctions in GSs' accounts. The satellite keeps these accounts which may or may not be accessible to the GSs. The amounts of the funds are determined by other criteria such as demands, priorities, service levels, etc. Note, however, that fund exchange does not necessarily involve monetary behavior from the GSs or users. In other words, the fund assigned to a GS is solely a variable for the purpose of the auction mechanism. The status of all the S SCs are reset to “available” at this step. The GSs also update their input vectors for capacity prediction (explained in section III) through most recently measured SNR or received power.

Step 1: Each GS predicts its SC capacities (i.e., η_{n,i,τ} in section III). The capacities of unavailable SCs are set to zero. Each GS sorts the SCs in the order of predicted capacities. The SCs are denoted as c₁, c₂, . . . c_{S} before sorting. After sorting, the SCs are indexed as cᵢ_{_{n,q}} at GS-n, 1−m≤N, 1≤q≤S. SC cᵢ_{_{n,1}} has the highest capacity of all SCs at GS-n. GS-n selects S′ₙ SCs that have the highest capacity. These S′ₙ SCs are the SCs to bid for the current round of bidding. The number of SCs S′ₙ is determined by the capacity distribution of SCs. An example of how S′ₙ is determined at GS-n is

$${S}_{n}^{′} = {arg max}_{j} ( {\sum }_{q = 1}^{j} {η}_{n , {i}_{n , q}} - \frac{j {\sum }_{q = 2}^{S} {η}_{n , {i}_{n , q}}}{S - 1} + \frac{{\sum }_{q = 1}^{S} {η}_{n , {i}_{n , q}} {\_Sη}_{n , {i}_{n , 1}}}{S - 1} )$$

where η_{n,i}_{_{n,q}} is the capacity of SC cᵢ_{_{n,q}}. Determining S′ₙ in such a way can avoid bidding on unavailable or low-quality SCs. It also allows GSs with strong fading to automatically put higher bids on good SCs while GSs with flatter channels automatically back up during first rounds of bidding—both spectral efficiency and fairness play a role in the auction. S′ₙ is also bound by parameters such as demands, fairness, etc.

Step 2: Due to the nature of fading and interference, the selected SCs by each GS in Step 1 are mostly fragmentary, i.e., selected SCs can be divided into a small number of groups and in each group SCs have continuous indices, as shown in FIG. 3. Assume GS-n groups its selected subcarriers into Gₙ groups, G_{n,1}, G_{n,2}, . . . G_{n,G}_{ₙ}, each of which contains the indices of that group. In the example in FIG. 3, G=2 for all three GSs, i.e., every GS bid for two groups of SCs. The GS assigns bid prices to these groups. An example of bid price assignment is as follows. Each GS-n first assigns a ratio

$${b}_{n , g} = {\sum }_{i ∈ {G}_{n , g}} {η}_{n , i} / {\sum }_{i ∈ {⋃}_{g} {G}_{n , g}} {η}_{n , i} 1 \leq g \leq {G}_{n}$$

to each group. GS-n sends this ratio, b_{n,g}, to the satellite. The satellite counts the bid S price of each of the SCs in G_{n,g} from GS-n proportionally as

$$\frac{{b}_{n , g} {M}_{n}}{\vert {G}_{n , g} \vert} ,$$

where Mₙ is the current total amount of fund in GS-n's account, |⋅| denotes the total number of SCs in a group.

Step 3: The GSs send their bids to the satellite through the control channel in uplink. An example of the bid messages is shown in FIG. 3. Each group of SCs to bid contains four mandatory fields: index of starting SC, total SC number in the group |G_{n,g}|, ratio b_{n,g}, and the lowest predicted capacity (or SNR, or spectral efficiency, or power) of the SCs in the group.

Step 4: The satellite allocates each SC that receives at least one bid to the GS that offers the highest bid. The allocation should meet other constraints such as maximal number of SCs per GS allowed, airtime fairness, etc. The satellite also updates that GS's account by deducting a certain amount from the account. An example of how much is charged to the account is the bid price, i.e.,

$$\frac{{b}_{n , g} {M}_{n}}{\vert {G}_{n , g} \vert} .$$

Another example is the second highest bid price, if the second highest bid price exists. The satellite then sends the allocation (and optionally the account balance) information of successfully sold SCs to GSs through the control channel in downlink. GSs set the status of all the sold SCs to “unavailable”.

Step 5: The satellite decides on whether each GS's capacity demand is met based on the downlink traffic that has been or is to be sent.

Step 6: The system decides if the total number of rounds of bidding has exceeded a certain number.

Step 7: The system continues or carries out data transmission using the final SC allocation for downlink. GSs' account may or may not reset to zero, i.e., rollover or not.

It is worth noting that downlink payload data transmission does not have to wait until the end of the auction process to start. The downlink transmission proceeds with the allocation from the previous auction result and then updates its allocation once the ongoing auction finishes. In other words, auctions proceed and update the allocation with the control channel and data channel going on concurrently.

### LSH-Based Capacity Prediction

In Step 1, the selection of SCs is based on the prediction of SC capacities. This prediction is based on an LSH-based algorithm described as follows.

The training phase of the algorithm builds a library L that maps patterns of capacity series into a set of predicted capacity values. This process is inspired by how a biological neural network was modeled in S. Dasgupta, C. F. Stevens, S. Navlakha, “A neural algorithm for a fundamental computing problem,” Science, vol. 358, no. 6364, pp. 793-796, November 2017. At each GS-n, whenever a new measurement of η_{n,i,t} becomes available at time of t for SC cᵢ, the GS updates the input vector η that consists of the most recent capacity values from the past. η has a fixed length of d. Then the GS multiplies the input vector η by a sparse random binary matrix R with a dimension of kd×d, which yields a vector, v, of length kd. k is a relatively large integer, e.g., 50. Each entry of matrix R is set to 1 with a small probability, e.g., 10%, and 0 with a high probability. The GS then sets the top 5% values in v to 1 while all others to 0, creating a winner-take-all representation, w= [symbol] (v). The transform of R and this winner-take-all operation together provide an expand-and-sparsify representation; encoding w is larger in dimension than the input and is also sparser, reducing the number of possible encodings and allowing multiple input series to be mapped to the same encoding. Lastly, the GS stores the pair of w and η_{n,i,t} into a hash table in which w is the key (add w if not already existing) and η_{n,i,t} is added to the value set corresponding to the key of w. Note that the hash table serving as the library is a mapping of [symbol] :{0,1}^{kd}→{ [symbol] }. To create a large enough library, the GS repeats the steps above for different t. Note that at each GS all the SCs share the same knowledge, i.e., they build into the same hash table. The pseudocode for this training process is as follows.

```
input: η_{n,i,-d}, η_{n,i,-d+1}, ... η_{n,i,-1}, 1 ≤ i ≤ S
initialize sparse binary matrix R = randbin(wd, d)
initialize hash table [symbol]     = { }
for t = 0,1,2 ... :
        input: η_{n,i,t}
        for i = 1,2, ... S :
          η = (η_{n,i,t-d}, η_{n,i,t-d+1}, ... η_{n,i,t-1})^{T}
          ν = Rη
          w = [symbol]    (ν)
          if w in keys of [symbol]    : [symbol]
                [w] ∪ {η_{n,i,t}} → [symbol]    [w]
          else: [symbol]
                [w] = {η_{n,i,t}}
          endif
output: [symbol]
```

In the test phase of the algorithm, to predict the capacity η_{n,i,τ} at time τ, the GS applies the same matrix R to its past values (η_{n,i,τ-d}, η_{n,i,τ-d+1}, . . . η_{n,i,τ-1})^{T}, applies a similar winner-take-all operation (we can decide a threshold for setting the encodings to binary instead of selecting the largest in order to further reduce computation complexity during running), and derives the encoding w_{τ}. Then the GS finds all the encodings in the hash table keys that have a Hamming distance smaller than δ and denotes them as \tilde{w}_{τ,j}, i.e., d_{H}(\tilde{w}_{τ,j},w_{τ})<δ, 1≤j≤J. δ should be chosen so that the number of satisfying encodings, J, is much smaller than the size of the hash table. Finally, the predicted capacity is determined by the weighted average of all the capacity values in the sets mapped from encodings \tilde{w}_{τ,j} according to the hash table,

$${\tilde{η}}_{n , i , τ} = \frac{{\sum }_{j = 1}^{J} {\sum }_{η ∈ ℒ [ {\tilde{w}}_{τ , j} ]} ( δ - {d}_{H} ( {\tilde{w}}_{τ , j} , {w}_{τ} ) ) η}{{\sum }_{j = 1}^{J} ( δ - {d}_{H} ( {\tilde{w}}_{τ , j} , {w}_{τ} ) ) \vert ℒ [ {\tilde{w}}_{τ , j} ] \vert} .$$

Every GS applies this process to all SCs (or selected SCs with interpolation). The capacity predictions from the formula directly above serve as the input to Step 1 of every auction at time t.

### Simulation and Experiment

In this section we examine the feasibility of the disclosed method by both simulation and experiment. In an example of Python simulation of 16 GSs and 600 SCs with downlink transmission experiencing frequency selective fading caused by multipath and interference, we find that the method improves communication efficiency compared with random allocations. FIG. 4 shows the method's performance on average capacity versus normalized transmitted downlink power. Under different SNR conditions, the method shows obvious improvement compared with randomly allocating SCs to GSs. On average, there is a 5.2-dB difference between the disclosed method and randomly assigning SCs. This is promising power saving for LEO satellites.

Compared with capacity limits, i.e., a satellite assigns each SC to the absolutely best GS without any fairness, the disclosed auction-based method has a small decrease relatively, while it guarantees much better fairness which can be examined by measuring the standard deviation (STD) of the capacity among the 16 GSs. FIG. 6B shows the simulated STD from the 16 GSs provided by 100 auction trials, i.e., run Steps of Auction 100 times for 100 instances of channel models. The disclosed method has a low STD similar to random allocation while producing a larger improvement than pursuing capacity limit extremes. This guarantees fairness in resource allocation.

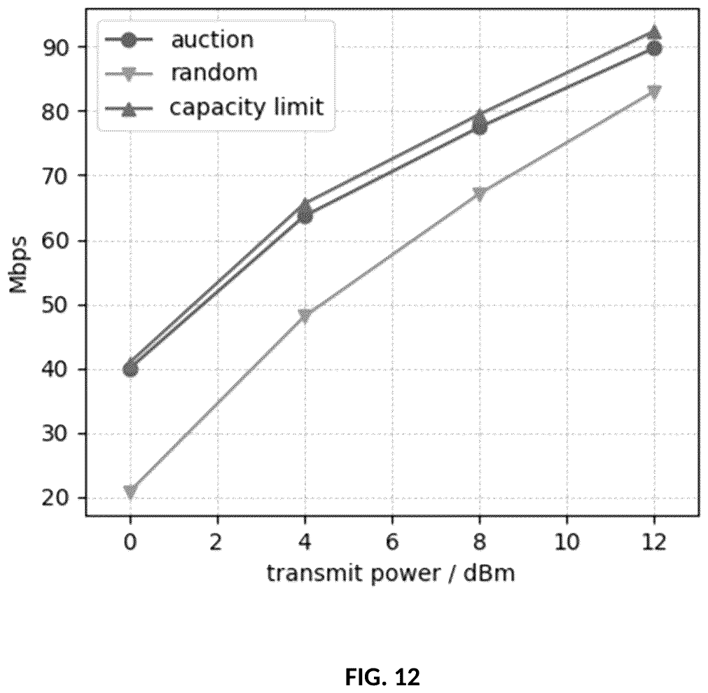

To further verify the method, a software-defined radio (SDR) setup was built with three transmitters (behaving as satellite transmitters) operating at adjacent bands and two receivers (behaving as two GSs) (Ettus X300). First, the training process was run to build the library for prediction and then repeatedly the Steps of Auction were run. We tested the methods performance on average capacity versus transmitted downlink power. As shown in FIG. 12, the method shows obvious improvement compared with randomly allocating SCs to receivers while having a small gap from capacity limit. A 2.2-dB power saving is observed on average. Although it is still a promising saving, it is lower than the 5.2-dB saving in the simulation result especially at a high-power region due to the lower number of receivers in the experiment setup.

Theoretically, this methodology has a downlink overhead like other methods. On the other hand, the disclosed mechanism reduces uplink overhead compared with systems that feedback complete channel status. To feedback complete channel status, each GS needs to pass a large amount of information containing complex coefficients, SNR, or received power of each SC to the satellite. For 600 subcarriers as an example, the same as what we used in the simulation, assuming the channel status for each SC takes 10 information bits to describe the channel characteristic, the total uplink overhead is 6,000 information bits per GS every time the SC allocation updates. On the other hand, in the disclosed method, assuming each bid message takes 40 bits (10 bits each field) in Step 3, we observed an average uplink overhead of 168 bits per GS every time the SC allocation updates. Compared with 6 kbit per GS per update, the method provides significant overhead reduction in uplink while performing similarly to a complete-information channel status feedback.

The method also simplifies computation complexity compared with optimal allocation. Optimal allocation, as aforementioned, is NP-hard while the computational complexity of the disclosed method is O(S) at the satellite and GS. In addition, the LSH prediction requires O(kdS) at a GS and none at satellites. This makes the method scale more feasibly when the number of GSs increases, causing less power consumption and overheating at the satellites.

### Channel Status Implication

The disclosed method can significantly reduce the uplink overhead by passing the minimal information reflecting downlink resource quality to satellites via bid messages. Although directly reading these messages at satellites cannot provide a conclusion on the downlink resource quality, the method does allow the derivation of such information through other mechanisms. Derivation of such information at satellites is important as the satellites may need to make adjustments (other than the allocation discussed in previous sections) of the downlink resources. An example is strong local interference at the GS sites that forces the satellites to avoid certain low SINR SCs.

In fact, the method enables the derivation of implicit channel information from the auctions. If a SC is left unsold repeatedly over many auctions, it is a sign that there may exist regional interference over these SCs. In this case, the satellite may decide to keep these SCs idle and adjust its power loading, i.e., power is unloaded from these interfered SCs to other useful SCs.

Furthermore, it is also very likely that an interfered SC is still bid for and sold as “cheap merchandise” at the end of an auction after no GSs bid for it for the first several rounds of bidding. In this case, monitoring interference using transaction prices provides higher accuracy than using bid messages. To show how this works, we added interference by decreasing the SNR of SC #300-#400 among the 600 SCs for all the 16 GSs in the simulation. These prices clearly imply which SCs are interfered with over the group of GSs that are located in the interfered area. Based on this implication, the satellite can carry out further power loading to improve system power efficiency, without explicitly needing to collect information from GSs with extra uplink overhead.

### Conclusion

In this example, we have proposed an auction-based mechanism to improve the efficiency of LEO satellite communication systems or similar communication systems that require lightweight downlink transmitters. The auction process allows the satellites to allocate downlink resources such as spectrum, satellite links, or radios, without needing to receive redundant channel status from GSs and thus reduce uplink overheads. In addition, an LSH-based prediction method helps make the resource quality prediction running at GSs with mainly binary data operations and a fast hash map—to exhibit low-complexity and fast responses at the same time. Simulations and experimental results demonstrate that the disclosed mechanism improves total channel capacity and reduces transmit power by dynamically leveraging the diversity among satellite-station links. Furthermore, the mechanism reduces uplink overhead by providing lightweight and effective channel status feedback. It also simplifies the computational complexity of LEO satellites, making the system more scalable. Last but not least, it enables the derivation of implicit resource information from the auctions. In summary, this mechanism provides a feasible solution for LEO satellites that are sensitive to power consumption and overheads, or any other complexity-distributed systems.

### REFERENCES

B. Deng, C. Jiang, H. Yao, S. Guo and S. Zhao, “The Next Generation Heterogeneous Satellite Communication Networks: Integration of Resource Management and Deep Reinforcement Learning”, in IEEE Wireless Communications, vol. 27, no. 2, pp. 105-111, April 2020.
X. Zhu, C. Jiang, L. Kuang, Z. Zhao, and S. Guo, “Two-Layer Game Based Resource Allocation in Cloud Based Integrated Terrestrial-Satellite Networks”, in IEEE Transactions on Cognitive Communications and Networking, vol. 6, no. 2, pp. 509-522, June 2020.
G. Zeng, Y. Zhan and X. Pan, “Failure-Tolerant and Low-Latency Telecommand in Mega-Constellations: The Redundant Multi-Path Routing,” in IEEE Access, vol. 9, pp. 34975-34985, 2021.
H. Xie, Y. Zhan, G. Zeng and X. Pan, “LEO Mega-Constellations for 6G Global Coverage: Challenges and Opportunities,” in IEEE Access, vol. 9, pp. 164223-164244, 2021.
G. Zeng, Y. Zhan, H. Xie, C. Jiang, “Networked Satellite Telemetry Resource Allocation for Mega Constellations,” in IEEE International Conference on Communications, ICC, 2022.
N. Pachler, I. del Portillo, E. F. Crawley, B. G. Cameron, “An Updated Comparison of Four Low Earth Orbit Satellite Constellation Systems to Provide Global Broadband,” in IEEE International Conference on Communications, 2021.
I. Bisio and M. Marchese, “Power Saving Bandwidth Allocation over GEO Satellite Networks”, in IEEE Communications Letters, vol. 16, no. 5, pp. 596-599, May 2012.
P. Huang, Y. Gai, B. Krishnamachari and A. Sridharan, “Subcarrier Allocation in Multiuser OFDM Systems: Complexity and Approximability,” IEEE Wireless Communication and Networking Conference, Sydney, NSW, 2010, pp. 1-6, 2010.
H. A. Ammar, R. Adve, S. Shahbazpanahi, G. Boudreau, and K. V. Srinivas, “Downlink Resource Allocation in Multiuser Cell-Free MIMO Networks With User-Centric Clustering”, in IEEE Transactions on Wireless Communications, vol. 21, no. 3, pp. 1482-1497, March 2022.
S. Dasgupta, C. F. Stevens, S. Navlakha, “A neural algorithm for a fundamental computing problem,” Science, vol. 358, no. 6364, pp. 793-796, November 2017.
I. Caragiannis, C. Kaklamanis, P. Kanellopoulos, M. Kyropoulou, B. Lucier, R. Paes Leme, E. Tardos, “Bounding the inefficiency of outcomes in generalized second price auctions,” Journal of Economic Theory, vol. 156, pp. 343-388, March 2015.
S. Mukherjee, B. A. Huberman, “Why Neural Networks Work,” arXiv:2211.14632.
B. Kempton and A. Riedl, “Network Simulator for Large Low Earth Orbit Satellite Networks,” in IEEE International Conference on Communications, ICC, 2021.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods, software and apparatus/devices can include a large number of optional elements and steps. All art-known functional equivalents of materials and methods are intended to be included in this disclosure. Nothing herein is to be construed as an admission that the invention is not entitled to antedate such disclosure by virtue of prior invention.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a processor” includes a plurality of such processors and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is/are not specifically disclosed herein.

What is claimed is:

1. A method for allocating a shared communication resource among a plurality of devices comprising:
receiving bids from the plurality of devices for the shared communication resource, wherein the shared communication resource comprises a plurality of resource units that are distributed in space, time, frequency and/or hardware;
wherein each device submits one or more of the bids that combined form one-hundred percent of the device's desired allotment of the shared communication resource, each of the bids specifying a ratio of a percentage of the desired allotment met by a quantity of non-distributed resource units;
allocating the resource units to the plurality of devices based at least in part on the ratios with highest values, thereby utilizing a small number of the non-distributed resource units to satisfice the devices' desired allotments; and
communicating with the plurality of devices according to the allocation.

2. The method of claim 1, wherein each bid comprises a starting resource unit identifier, a total number of non-distributed resource units in the bid, the percentage of the desired allotment met by the bid, and a performance parameter for one of the non-distributed resource units in the bid.

3. The method of claim 2, wherein the performance parameter is selected from the group consisting of capacity, signal-to-interference-plus-noise ratio (SINR), modulation error ratio (MER), bit error rate (BER), error vector magnitude (EVM), modulation order and power usage.

4. The method of claim 1, wherein the devices are selected from the group consisting of user equipment, mobile stations, IoT devices, base stations, ground stations and satellites.

5. The method of claim 1, wherein the one or more bids submitted from each device is/are based on device-specific historical data.

6. The method of claim 5, wherein the device-specific historical data are selected from the group consisting of channel estimates, complex coefficients, signal-to-noise ratio (SNR), signal-to-interference-plus-noise ratio (SINR), capacity, modulation error ratio (MER), bit error rate (BER), error vector magnitude (EVM), modulation order and received power.

7. The method of claim 1, wherein at least one of the plurality of devices uses a predictive algorithm to identify the resource unit(s) of highest quality.

8. The method of claim 7, wherein the predictive algorithm performs one or more of locality sensitive hashing (LSH), linear regression, polynomial regression, autoregressive integrated moving averaging (ARIMA), neural networking, recursive neural networking (RNN), Long Short-Term Memory (LSTM), K-nearest neighbor determinations and transformers.

9. The method of claim 1 further comprising identifying ineffective ones of the resource units based on a scarcity of bids for the resource units.

10. The method of claim 9, further comprising reducing power to the resource units that are ineffective.

11. The method of claim 1, wherein the shared communication resource is a downlink resource.

12. The method of claim 1, wherein the shared communication resource is selected from the group consisting of spectrum, an antenna, a transmitter, a radio link, a MIMO beam, a satellite link, a mesh node, a network node, time and space.

13. The method of claim 1, wherein none of the devices submit channel state information.

14. A system for allocating a shared communication resource among a plurality of devices comprising:
a processor configured to:
receive bids from the plurality of devices for the shared communication resource, wherein the shared communication resource comprises a plurality of resource units that are distributed in space, time, frequency and/or hardware;
wherein each device submits one or more of the bids that combined form one-hundred percent of the device's desired allotment of the shared communication resource, each of the bids specifying a ratio of a percentage of the desired allotment met by a quantity of non-distributed resource units;
allocate the resource units to the plurality of devices based at least in part on the ratios with highest values, thereby utilizing a small number of the non-distributed resource units to satisfice the devices' desired allotments; and
arrange communication with the plurality of devices according to the allocation.

15. The system of claim 14, wherein the processor is further configured to identify ineffective ones of the resource units based on a scarcity of bids for the resource units.

16. A non-transitory computer-readable medium having a plurality of non-transitory instructions executable with a processor to allocate a shared communication resource among a plurality of devices, the plurality of non-transitory instructions being executable for:
receiving bids from the plurality of devices for the shared communication resource, wherein the shared communication resource comprises a plurality of resource units that are distributed in space, time, frequency and/or hardware;
wherein each device submits one or more of the bids that combined form one-hundred percent of the device's desired allotment of the shared communication resource, each of the bids specifying a ratio of a percentage of the desired allotment met by a quantity of non-distributed resource units;
allocating the resource units to the plurality of devices based at least in part on the ratios with highest values, thereby utilizing a small number of the non-distributed resource units to satisfice the devices' desired allotments; and
communicating with the plurality of devices according to the allocation.

17. The non-transitory computer-readable medium of claim 16, wherein none of the devices submit channel state information.

18. The non-transitory computer-readable medium of claim 16, wherein the plurality of non-transitory instructions is further executable for identifying ineffective ones of the resource units based on a scarcity of bids for the resource units.

19. The non-transitory computer-readable medium of claim 16, wherein the plurality of non-transitory instructions is further executable for reducing power to the resource units that are ineffective.

20. The non-transitory computer-readable medium of claim 17, wherein the plurality of non-transitory instructions is further executable for deducting an amount of funds from each device's account after the step of allocating.
